(19) United States
(12) Patent Application Publication
(10) Pub. No.: US 2016/0198526 A1
(43) Pub. Date: Jul. 7, 2016

(54) COOKING APPLIANCES HAVING IMPROVED HEATING ELEMENT OPERATION

(71) Applicant: General Electric Company, Schenectady, NY (US)

(72) Inventors: Jaime Alexander McPherson, Signal Mountain, TN (US); Frank J. Hellwig, East Ridge, TN (US)

(21) Appl. No.: 14/591,373

(22) Filed: Jan. 7, 2015

(51) Int. Cl. H05B 1/02; H05B 3/76

(52) U.S. Cl. CPC H05B 1/0266; H05B 1/0213; H05B 3/76

(57) ABSTRACT

Cooking appliances are provided. A cooking appliance includes a cooktop including at least one heating element assembly which includes a first heating element, a second heating element, and a third heating element. The cooking appliance further includes an energy regulator coupled to the heating element assembly and operable to selectively activate the first, second and third heating elements in an activation pattern. During a first segment of the activation pattern the first heating element is active and the second and third heating elements are inactive. During a second segment of the activation pattern the first and second heating elements are active and the third heating element is inactive. During a third segment of the activation pattern the first, second and third heating elements are active for a first portion and the first and second heating elements are active and the third heating element is inactive for a second portion.

### FIELD OF THE INVENTION

The present disclosure relates generally to cooking appliances, and more particularly to the operation of heating elements of cooking appliances.

### BACKGROUND OF THE INVENTION

Cooking appliances are frequently utilized in a variety of settings to cook food items. A cooking appliance may include a cooktop, and may further include a cooking chamber configured for receipt of items to be cooked. The cooktop may include one or more heating element assemblies which can be activated to produce heat and facilitate cooking of items placed on the cooktop.

Heating element assemblies typically include one or more heating elements, which can be activated in defined activation patterns during operation of the cooking appliance. Further, in many cases, an energy regulator (also conventionally known as an infinite switch) is coupled to the heating element assembly. The energy regulator is operable to selectively activate the heating elements in accordance with the activation pattern.

In one specific embodiment, a heating element assembly may include three heating elements. A typically known activation pattern for a triple element heating element assembly includes sequentially a first segment wherein only one heating element is active, a second segment wherein two heating elements are active, and a third segment wherein all three heating elements are active. All three heating elements may be inactive between the third and first segments.

However, concerns have been raised about the power output from such heating element assemblies during the third segment, when all three heating elements are active. In particular, concerns have been raised that the lowest power output during the third segment is relatively too high.

Accordingly, improved cooking appliances and heating element assemblies therefor are desired. In particular, heating element assemblies which provide an increased power output range would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment, a cooking appliance is provided. The cooking appliance includes a cooktop comprising at least one heating element assembly, the at least one heating element assembly including a first heating element, a second heating element, and a third heating element. The cooking appliance further includes an energy regulator coupled to the heating element assembly and operable to selectively activate the first heating element, second heating element, and third heating element in an activation pattern. During a first segment of the activation pattern the first heating element is active and the second heating element and third heating element are inactive. During a second segment of the activation pattern the first heating element and second heating element are active and the third heating element is inactive. During a third segment of the activation pattern the first heating element, second heating element and third heating element are active for a first portion and the first heating element and second heating element are active and the third heating element is inactive for a second portion.

In accordance with one embodiment, a cooking appliance is provided. The cooking appliance includes a cooktop comprising at least one heating element assembly, the at least one heating element assembly including a first heating element, a second heating element, and a third heating element. The cooking appliance further includes an energy regulator coupled to the heating element assembly and operable to selectively activate the first heating element, second heating element, and third heating element in an activation pattern. The energy regulator includes a rotatable shaft and a main cam and auxiliary cam each coupled to the rotatable shaft. Rotation of the shaft in a rotation direction through 360 degrees from an initial position provides the selective activation of the first heating element, second heating element, and third heating element in the activation pattern. During a first segment of the activation pattern the first heating element is active and the second heating element and third heating element are inactive. During a second segment of the activation pattern the first heating element and second heating element are active and the third heating element is inactive. During a third segment of the activation pattern the first heating element, second heating element and third heating element are active for a first portion and the first heating element and second heating element are active and the third heating element is inactive for a second portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a cooking appliance in accordance with one embodiment of the present disclosure;

FIG. 2 provides a top view of a heating element assembly coupled to an energy regulator for a cooking appliance in accordance with one embodiment of the present disclosure;

FIG. 3 provides a schematic view of an energy regulator for a cooking appliance in accordance with one embodiment of the present disclosure;

FIG. 4 provides a top view of a main cam of an energy regulator for a cooking appliance in accordance with one embodiment of the present disclosure;

FIG. 5 provides a top view of various components of an energy regulator for a cooking appliance in accordance with one embodiment of the present disclosure;

FIG. 6 provides a bottom view of various components of an energy regulator for a cooking appliance in accordance with one embodiment of the present disclosure;

FIG. 7 provides a graph of duty cycle versus rotation of a shaft of an energy regulator through 360 degrees from an initial position in accordance with one embodiment of the present disclosure; and

FIG. 8 provides a table illustrating the activation status of each heating element of a heating element assembly along with duty cycle for the heating element assembly at various points during rotation of a shaft of an energy regulator through 360 degrees from an initial position in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

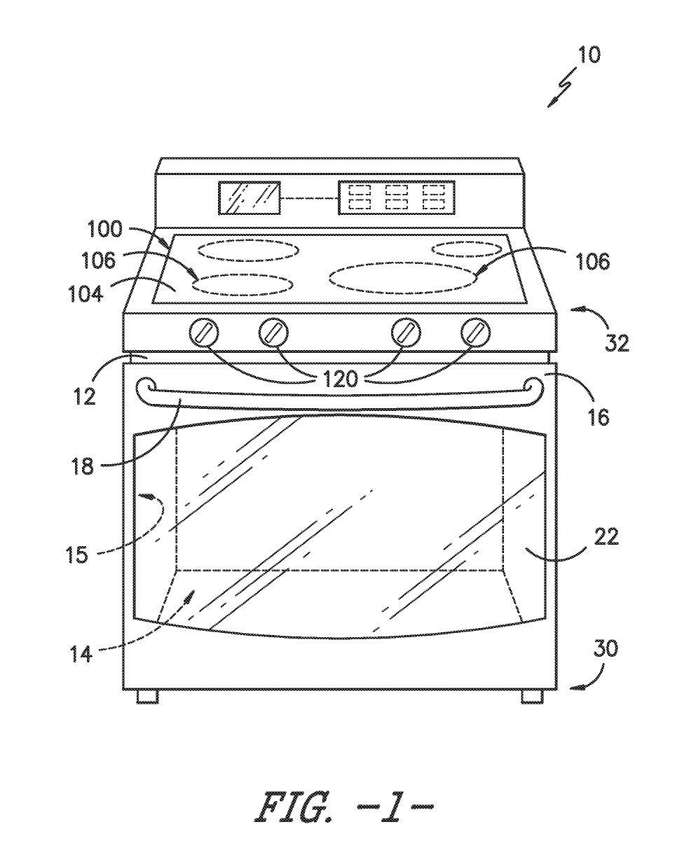

FIG. 1 provides a perspective view of a cooking appliance 10 according to an exemplary embodiment of the present subject matter. Cooking appliance 10 is provided by way of example only and is not intended to limit the present subject matter in any aspect. Thus, the present subject matter may be used with other cooking appliance configurations, e.g., that define one or more interior cavities for the receipt of food, or that do not include interior cavities and that only include cooktops. Further, the present subject matter may be used in any other suitable appliance.

Cooking appliance 10 may, as shown, include an insulated cabinet 12 with an interior cooking chamber 14 defined by an interior surface 15 of cabinet 12. Cooking chamber 14 is configured for the receipt of one or more food items to be cooked. Cooking appliance 10 includes a door 16 rotatably mounted to cabinet 12, e.g., with a hinge (not shown). A handle 18 is mounted to door 16 and assists a user with opening and closing door 16 in order to access cooking chamber 14. For example, a user can pull on handle 18 to open or close door 16 and access cooking chamber 14.

Cooking appliance 10 can include a seal (not shown) between door 16 and cabinet 12 that assist with maintaining heat and cooking fumes within cooking chamber 14 when door 16 is closed. Multiple parallel glass panes 22 provide for viewing the contents of cooking chamber 14 when door 16 is closed and assist with insulating cooking chamber 14. Baking racks (not shown) may be positioned in cooking chamber 14 for the receipt of food items or utensils containing food items.

Various heating elements may be provided for heating of the cooking chamber. For example, a gas fueled or electric bottom heating element (e.g., a gas burner or a bake gas burner) may be positioned in cabinet 12, e.g., adjacent a bottom portion 30 of cabinet 12. Bottom heating element may be used to heat cooking chamber 14 for both cooking and cleaning of cooking appliance 10. The size and heat output of the bottom heating element can be selected based on the e.g., the size of cooking appliance 10. A top heating element (e.g. an electric, gas, microwave, halogen, or other) heating element, can also positioned in cooking chamber 14 of cabinet 12, e.g., adjacent a top portion 32 of cabinet 12. Top heating element is used to heat cooking chamber 14 for both cooking/broiling and cleaning of cooking appliance 10. Like the bottom heating element, the size and heat output of the top heating element can be selected based on the e.g., the size of cooking appliance 10.

Cooking appliance 10 may additionally or alternatively include a cooktop 100. Cooktop 100 may be disposed on the cabinet 12, or may be a standalone appliance. As show, cooktop 100 may include a top panel 104. By way of example, top panel 104 may be constructed of glass, ceramics, enameled steel, and combinations thereof. One or more heating element assemblies 106, which in this embodiment are electric heating assemblies, may be mounted, for example, below the top panel 104. While shown with four heating element assemblies 106 in the exemplary embodiment of FIG. 1, cooktop appliance 100 may include any number of heating element assemblies 106 in alternative exemplary embodiments. Heating element assemblies 106 can also have various diameters. For example, each heating element assembly 106 can have a different diameter, the same diameter, or any suitable combination thereof. As discussed herein, activation of a heating element assembly 106 can cause electricity to be flowed from a power source (not shown) to various heating elements of the heating element assembly 106, which in turn can cause the heating element assembly 106 to generate heat. This heat may be transferred through the top panel 104 to utensils positioned on the top panel 104.

Activation of each heating element assembly 106 may be accomplished through user interaction with an input device 120, which may be a knob as shown. A separate input device 120 may, for example, be coupled to each heating element assembly 106. Rotation of an input device 120 may rotate a shaft of a switch, such as an energy regulator, which may activate the associated heating element assembly as discussed herein.

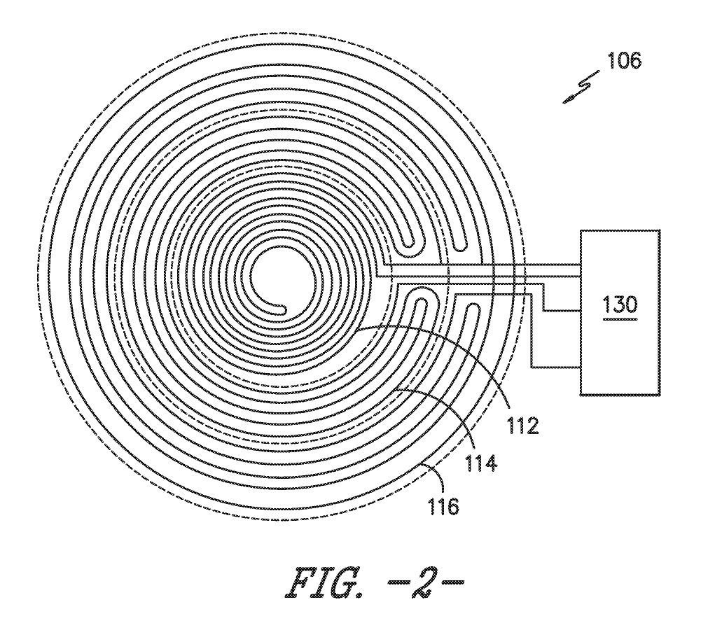

Referring now to FIG. 2, an exemplary heating element assembly 106 is illustrated. Heating element assembly 106 includes a first heating element 112, a second heating element 114, and a third heating element 116. The heating elements are arranged in a substantially concentric pattern such that each of the heating elements supplies heat to a specific portion or zone of a cooking area of the cooktop 100 when activated. In the illustrative embodiment, the cooking area is divided into three heating zones that roughly correspond in size to the outer diameter of each of the heating elements. In exemplary embodiments, the first heating element 112 is an innermost heating element, the second heating element 114 is an intermediate heating element, and the third heating element is an outermost heating element, as shown. Alternatively, however, the heating elements 112, 114, 116 could have other suitable arrangements.

The heating element assembly 106 and the heating elements 112, 114, 116 thereof are coupled to an energy regulator 130. As is generally understood, an energy regulator 130 is a switching device that selectively activates the various heating elements 112, 114, 116. For example, rotation of the knob 120 associated with an energy regulator 130 may cause the energy regulator to selectively activate the various heating elements 112, 114, 116 as discussed herein.

It should be generally understood that each heating element 112, 114, 116 is in communication, through the energy regulator 130, with a power source that provides electrical power to the heating elements 112, 114, 116. When a heating element is active or activated, electrical power is being provided to the heating element through the energy regulator 130 and the heating element is producing power (and thus heat). When a heating element is inactive or deactivated, electrical power is not being provided to the heating element.

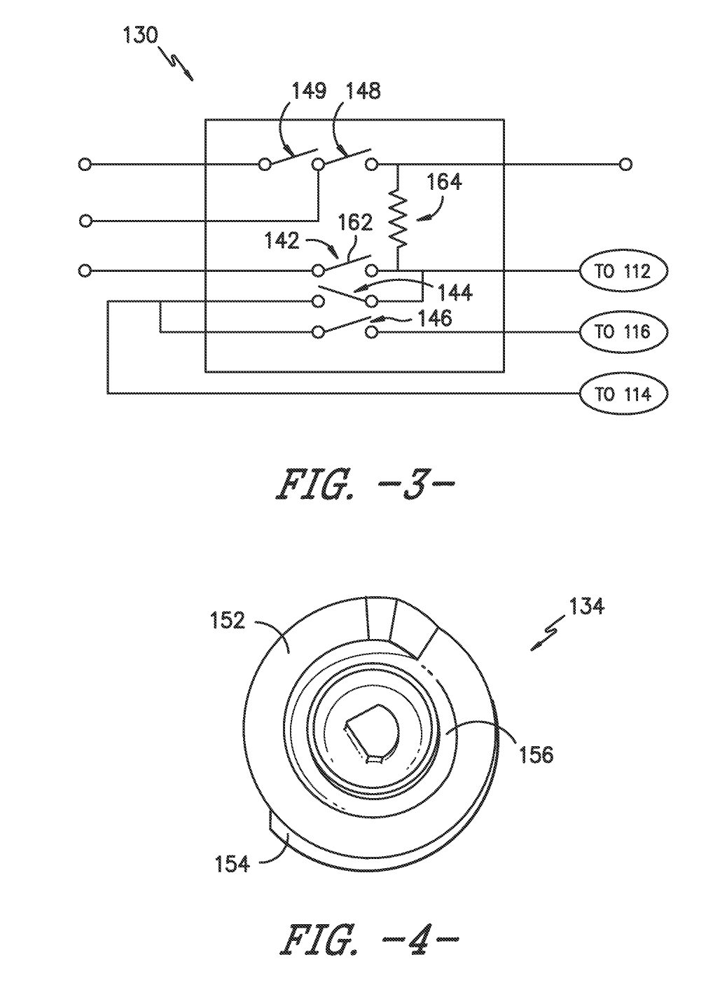

Referring now to FIG. 3, a schematic view of an energy regulator 130 is provided in accordance with one embodiment of the present disclosure. Additionally, FIGS. 4 through 6 illustrate various components of an energy regulator 130 in accordance with one embodiment of the present disclosure. Energy regulator 130 includes shaft 132 which is generally rotatable about its longitudinal axis. The shaft 132, as discussed, may be connected to a knob 120, such that user rotation of the knob 120 may rotate the shaft 132. Various cams may be coupled to the rotatably shaft 132, such that rotation of the shaft 132 rotates the cams. For example, as illustrated, energy regulator 130 may include a main cam 134 and an auxiliary cam 136. Each cam may be coupled to the shaft 132.

The cams 134, 136 may operate to open and close various electrical contacts to activate and deactivate the various heating elements 112, 114, 116. For example, as shown, energy regulator 130 may include a first electrical contact 142 which is in electrical communication with the first heating element 112, a second electrical contact 144 which is in electrical communication with the second heating element 114, and a third electrical contact 146 which is in electrical communication with the third heating element 116. Accordingly, for example, when the first electrical contact 142 is closed, an electrical circuit may be completed such that the first heating element 112 is activated. When the second electrical contact 144 is closed (along with the first electrical contact 142 in these embodiments), an electrical circuit may be completed such that the second heating element 114 is activated. When the third electrical contact 146 is closed (along with the first and second electrical contacts 142, 144 in these embodiments), an electrical circuit may be completed such that the third heating element 116 is activated.

It should be noted, and is generally understood, that the various electrical contacts as shown and described herein are formed by various conductive members which may contact each other when a contact is closed and be spaced from each other when a contact is open to form the various circuits as required herein.

Additionally, energy regulator 130 may include an assembly activation contact 148 and a pilot contact 149, as shown. When closed, the assembly activation contact 148 and pilot contact 149 may complete a circuit which allows the heating elements 112, 114, 116 to be activated when the first, second, and third contacts 142, 144, 146 are closed as discussed above. When the assembly activation contact 148 is open, the circuit is not completed, such that none of the heating elements 112, 114, 116 can be activated.

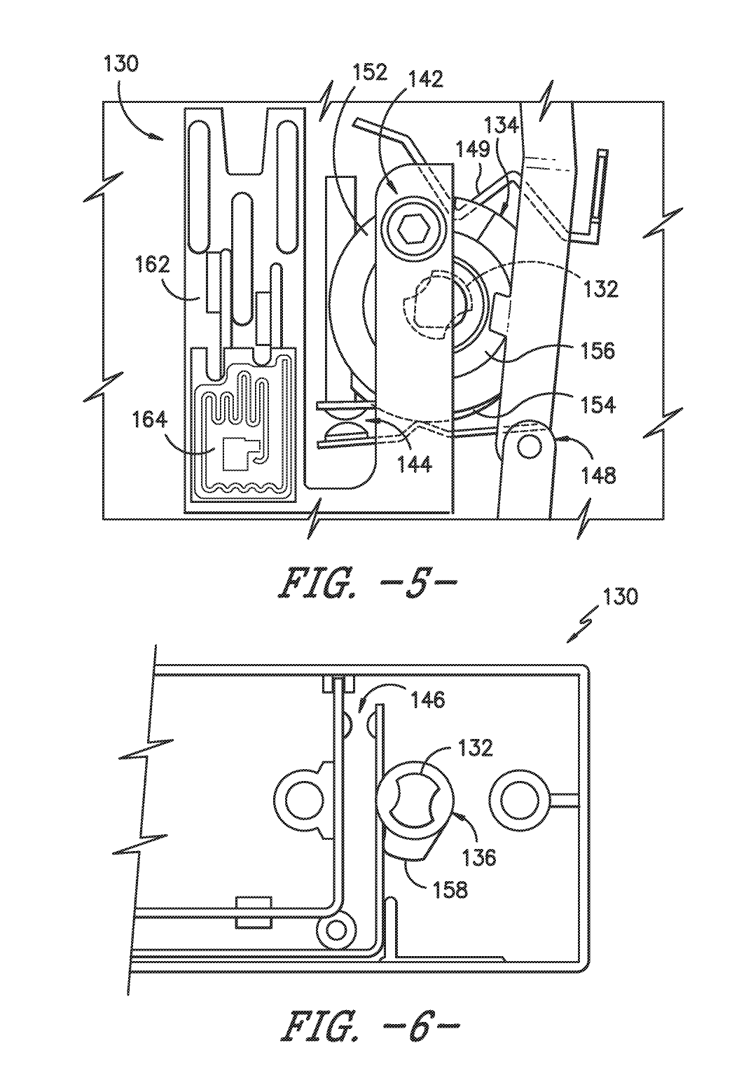

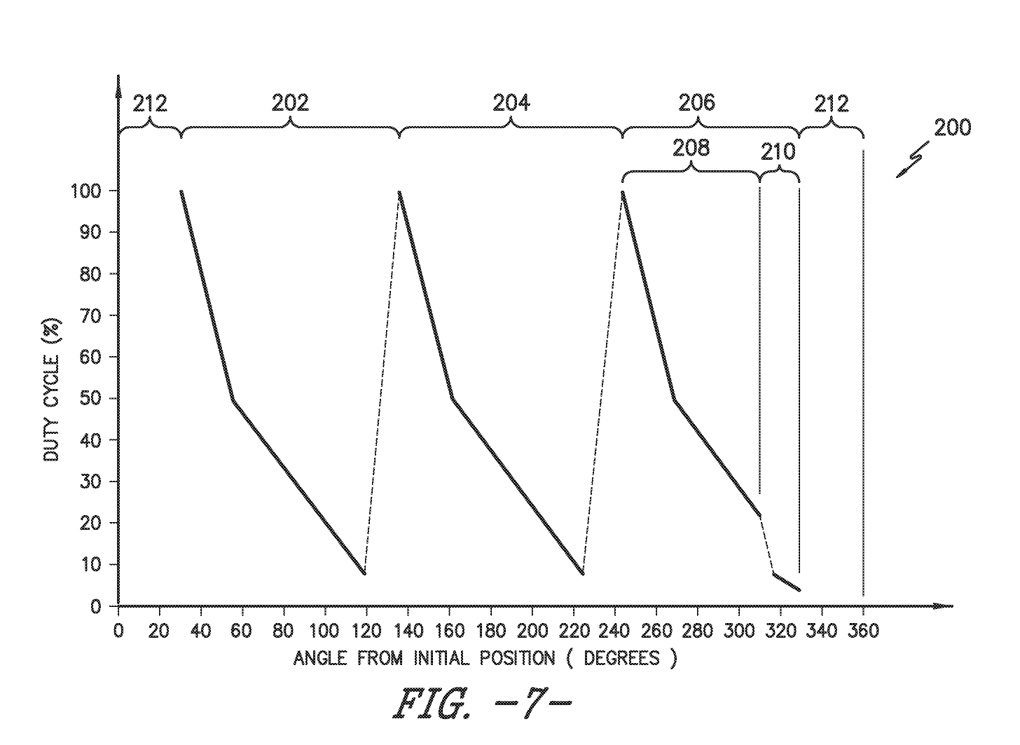

In exemplary embodiments as shown, the first contact 142, second contact 144, assembly activation contact 148 and pilot contact 149 may be operable by the main cam 134, while the third contact 146 is operable by the auxiliary cam 136. FIG. 3 schematically illustrates the electrical arrangement of these various contacts. FIG. 5 illustrates the interaction between conductive members that form the first contact 142, second contact 144, assembly activation contact 148 and pilot contact 149 and the main cam 134. FIG. 6 illustrates interaction between conductive members that form the third contact 146 and the auxiliary cam 136.

Notably, and as shown in FIGS. 4 and 5, main cam 134 includes a number of cam surfaces which interact with the various conductive members that form the various contacts. For example, a first cam surface 152 interacts with a conductive member that forms the first contact 142, a second cam surface 154 interacts with a conductive member that forms the second contact surface 144, and a third cam surface 156 interacts with a conductive member that forms the assembly activation contact 148. Rotation of the shaft 132 causes rotation of the cam 134 and thus the cam surface 152, 154, 156 thereof, which in turn causes movement of the corresponding conductive members and resulting opening and closing of the contacts 142, 144, 148.

Auxiliary cam 136 includes a cam surface 158 which interacts with a conductive member that forms the third contact 146. Rotation of the shaft 132 causes rotation of the cam 136 and thus the cam surface 158 thereof, which in turn causes movement of the corresponding conductive member and resulting opening and closing of the contact 146.

As further illustrated in FIGS. 3 and 5, energy regulator 130 may include a bimetal element 162 and a heater element 164. The first electrical contact 142 is further operable by the bimetal element 162 and the heater element 164. For example, as shown, the bimetal element 162 is the conductive member that interacts with the first cam surface 152, and is one of the conductive members that forms the first contact 142. The first cam surface 152 adjusts the size of the gap of the first contact 142 when open, and the heater element 164 is alternative activated and deactivated to alternatively open and close the first contact 142 in a cycling fashion as is generally understood. Adjustment of the size of the gap of the first contact 142 when open thus adjusts the duty cycle (discussed herein) of the heating element assembly 106.

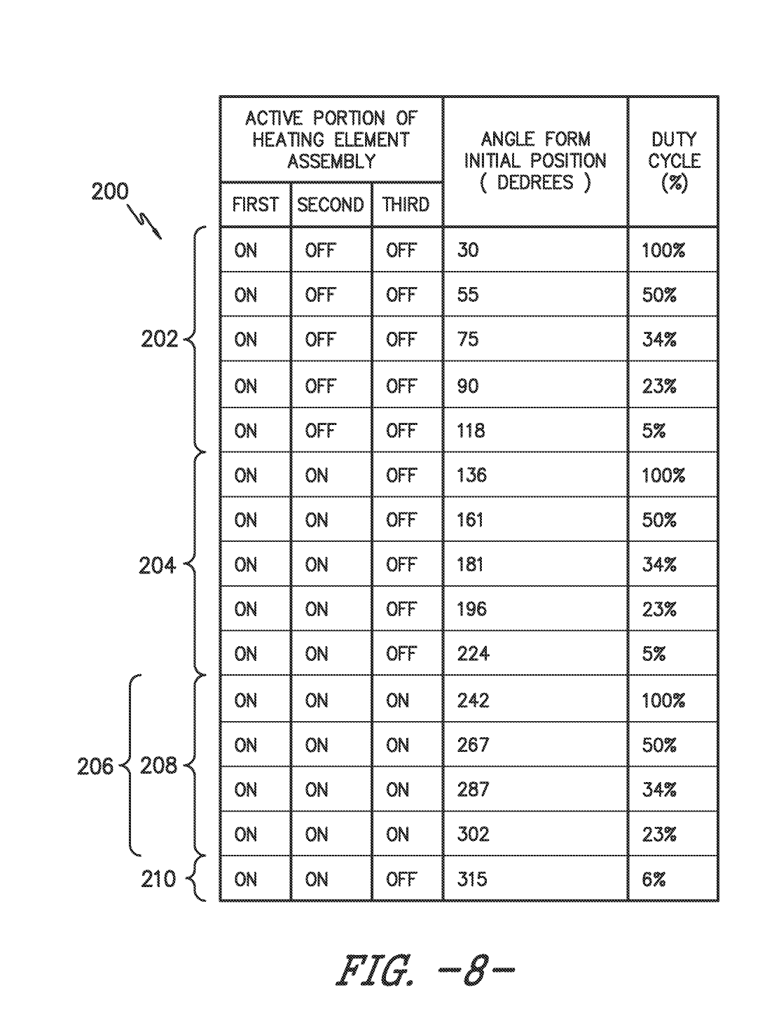

Referring now to FIGS. 7 and 8, energy regulator 130 is operable to selectively activate the first heating element 112, second heating element 114, and third heating element 116 in an activation pattern 200. Activation pattern 200 is generally a pattern of activation and deactivation of the various heating elements 112, 114, 116. In particular, in exemplary embodiments rotation of the shaft 132 in a rotation direction through 360 degrees from an initial position provides the selective activation of the heating elements 112, 114, 116 in the activation pattern. FIG. 7 provides a graph of duty cycle versus rotation of the shaft of an energy regulator through 360 degrees from an initial position in accordance with one embodiment of the present disclosure. FIG. 8 provides a table illustrating the activation status of each heating element 112, 114, 116 along with a duty cycle for the heating element assembly 106 at various points during rotation of the shaft 130 through 360 degrees from the initial position in accordance with one embodiment of the present disclosure.

In the embodiments shown, the rotation direction is a counter-clockwise direction. Alternatively, however, the rotation direction could be a clockwise direction. Further, it should be understood that in exemplary embodiments rotation in the opposite direction of the rotation direction would simply result in selective activation of the heating elements 112, 114, 116 in an opposite manner through the activation pattern.

Additionally, it should be noted that in exemplary embodiments, the heating elements 112, 114, 116 are all inactive in the initial position. This generally corresponds to a position of the main cam 134 such that the assembly activation contact 148 is open.

Activation pattern 200 may include various segments and portions of segments wherein select elements of the heating elements 112, 114, 116 are active, and wherein the heating element assembly 106 is operating at various duty cycles. As shown, during a first segment 202 of the activation pattern 200 the first heating element 112 is active and the second heating element 114 and third heating element 116 are inactive. This generally corresponds to a position of the main cam 134 such that the assembly activation contact 148 is closed, the first electrical contact 142 is closed or closable in a cycling manner, and the second electrical contact 144 is open, and a position of the auxiliary cam 136 such that the third electrical contact 146 is open. As shown, due to the position of the main cam 134 during rotation through the first segment 202, the duty cycle of the heating element assembly 106 may decrease during such rotation through the first segment 202.

During a second segment 204 of the activation pattern 200 the first heating element 112 and the second heating element 114 are active and the third heating element 116 is inactive. This generally corresponds to a position of the main cam 134 such that the assembly activation contact 148 is closed, the first electrical contact 142 is closed or closable in a cycling manner, and the second electrical contact 144 is closed, and a position of the auxiliary cam 136 such that the third electrical contact 146 is open. As shown, due to the position of the main cam 134 during rotation through the second segment 204, the duty cycle of the heating element assembly 106 may decrease during such rotation through the second segment 204.

Activation pattern 200 may further include a third segment 206. Third segment 206 may include a first portion 208 and a second portion 210. During the first portion 208, the first heating element 112, second heating element 114 and third heating element 116 are active. This generally corresponds to a position of the main cam 134 such that the assembly activation contact 148 is closed, the first electrical contact 142 is closed or closable in a cycling manner, and the second electrical contact 144 is closed, and a position of the auxiliary cam 136 such that the third electrical contact 146 is closed. During the second portion 210, the first heating element 112 and second heating element 114 are active and the third heating element 116 is inactive. This generally corresponds to a position of the main cam 134 such that the assembly activation contact 148 is closed, the first electrical contact 142 is closed or closable in a cycling manner, and the second electrical contact 144 is closed, and a position of the auxiliary cam 136 such that the third electrical contact 146 is open. Notably, in exemplary embodiments the second portion occurs after the first portion during rotation of the shaft 132 in the rotation direction. As shown, due to the position of the main cam 134 during rotation through the second segment 204, the duty cycle of the heating element assembly 106 may decrease during such rotation through the second segment 204.

The operation of the energy regulator 130 in the third segment 206 advantageously reduces the lower power output experienced during such third segment 206. In particular, the use of a second portion 210 wherein the third heating element 116 is inactive, and the modification of the auxiliary cam 136 to facilitate such second portion 210, provide such advantageous performance.

Notably, in exemplary embodiments, the first, second and third segments 202, 204, 206 occur sequentially. Accordingly, during rotation of the shaft 130 from the initial position in the rotation direction, the first segment 202 occurs before the second segment 204 and the second segment 204 occurs before the third segment 206. For example, in some embodiments, the first segment 202 occurs during rotation of the shaft 132 within a range between approximately 30 degrees and approximately 120 degrees from the initial position. Further, in some embodiments, the second segment 204 occurs during rotation of the shaft 132 within a range between approximately 120 degrees and approximately 230 degrees from the initial position. Still further, in some embodiments, the third segment 206 occurs during rotation of the shaft 132 within a range between approximately 230 degrees and approximately 330 degrees from the initial position. Within the third segment 206, the first portion 208 may for example occur during rotation of the shaft 132 within a range between approximately 230 degrees and approximately 315 degrees, and the second portion 210 may occur during rotation of the shaft 132 within a range between approximately 315 degrees and approximately 330 degrees.

It should be understood, however, that the present disclosure is not limited to the above-disclosed ranges, and rather that any suitable ranges are within the scope and spirit of the present disclosure.

Further, it should be noted that in exemplary embodiments the activation pattern 200 additionally includes a fourth segment 212 wherein the first heating element 112, second heating element 114 and third heating element 116 are inactive. This generally corresponds to a position of the main cam 134 such that the assembly activation contact 148 is open, the first electrical contact 142 is open, and the second electrical contact 144 is open, and a position of the auxiliary cam 136 such that the third electrical contact 146 is open. Notably, the initial position may be included within the fourth segment 212. For example, in some embodiments, the fourth segment 212 occurs during rotation of the shaft 132 within a range between approximately 330 degrees and approximately 30 degrees from the initial position, and thus includes the initial position (which is 0 degrees for purposes of the angles and ranges disclosed herein).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, comprising:
a cooktop comprising at least one heating element assembly, the at least one heating element assembly comprising a first heating element, a second heating element, and a third heating element; and
an energy regulator coupled to the heating element assembly and operable to selectively activate the first heating element, second heating element, and third heating element in an activation pattern,
wherein during a first segment of the activation pattern the first heating element is active and the second heating element and third heating element are inactive, during a second segment of the activation pattern the first heating element and second heating element are active and the third heating element is inactive, and during a third segment of the activation pattern the first heating element, second heating element and third heating element are active for a first portion and the first heating element and second heating element are active and the third heating element is inactive for a second portion.

2. The cooking appliance of claim 1, wherein the energy regulator comprises a rotatable shaft, wherein rotation of the shaft in a rotation direction through 360 degrees from an initial position provides the selective activation of the first heating element, second heating element, and third heating element in the activation pattern.

3. The cooking appliance of claim 2, wherein the energy regulator further comprises a main cam and an auxiliary cam each coupled to the rotatable shaft.

4. The cooking appliance of claim 3, wherein the energy regulator further comprises a first electrical contact in electrical communication with the first heating element, a second electrical contact in electrical communication with the second heating element, and a third electrical contact in electrical communication with the third heating element, the first and second electrical contacts operable by the main cam, the third electrical contact operable by the auxiliary cam.

5. The cooking appliance of claim 4, wherein the energy regulator further comprises a bimetal element and a heater element, and wherein the first electrical contact is further operable by the bimetal element and the heater element.

6. The cooking appliance of claim 2, wherein the second portion occurs after the first portion during rotation of the shaft in the rotation direction.

7. The cooking appliance of claim 2, wherein the rotation direction is a counter-clockwise direction.

8. The cooking appliance of claim 2, wherein during rotation of the shaft from the initial position in the rotation direction, the first segment of the activation pattern occurs before the second segment and the second segment occurs before the third segment.

9. The cooking appliance of claim 2, wherein the first segment of the activation pattern occurs during rotation of the shaft within a range between approximately 30 degrees and approximately 120 degrees from the initial position, the second segment of the activation pattern occurs during rotation of the shaft within a range between approximately 120 degrees and approximately 230 degrees from the initial position, and the third segment of the activation pattern occurs during rotation of the shaft within a range between approximately 230 degrees and approximately 330 degrees from the initial position.

10. The cooking appliance of claim 9, wherein the first portion occurs during rotation of the shaft within a range between approximately 230 degrees and approximately 315 degrees, and wherein the second portion occurs during rotation of the shaft within a range between approximately 315 degrees and approximately 330 degrees.

11. The cooking appliance of claim 1, wherein during a fourth segment of the activation pattern the first heating element, second heating element and third heating element are inactive.

12. The cooking appliance of claim 1, wherein the at least one heating element assembly is a plurality of heating element assemblies.

13. The cooking appliance of claim 1, further comprising a cabinet defining a cooking chamber, the cooking chamber configured for receipt of items to be cooked.

14. A cooking appliance, comprising:
a cooktop comprising at least one heating element assembly, the at least one heating element assembly comprising a first heating element, a second heating element, and a third heating element; and
an energy regulator coupled to the heating element assembly and operable to selectively activate the first heating element, second heating element, and third heating element in an activation pattern, the energy regulator comprising a rotatable shaft and a main cam and auxiliary cam each coupled to the rotatable shaft, wherein rotation of the shaft in a rotation direction through 360 degrees from an initial position provides the selective activation of the first heating element, second heating element, and third heating element in the activation pattern,
wherein during a first segment of the activation pattern the first heating element is active and the second heating element and third heating element are inactive, during a second segment of the activation pattern the first heating element and second heating element are active and the third heating element is inactive, and during a third segment of the activation pattern the first heating element, second heating element and third heating element are active for a first portion and the first heating element and second heating element are active and the third heating element is inactive for a second portion.

15. The cooking appliance of claim 14, wherein the energy regulator further comprises a first electrical contact in electrical communication with the first heating element, a second electrical contact in electrical communication with the second heating element, and a third electrical contact in electrical communication with the third heating element, the first and second electrical contacts operable by the main cam, the third electrical contact operable by the auxiliary cam.

16. The cooking appliance of claim 15, wherein the energy regulator further comprises a bimetal element and a heater element, and wherein the first electrical contact is further operable by the bimetal element and the heater element.

17. The cooking appliance of claim 14, wherein the second portion occurs after the first portion during rotation of the shaft in the rotation direction.

18. The cooking appliance of claim 14, wherein the rotation direction is a counter-clockwise direction.

19. The cooking appliance of claim 14, wherein during rotation of the shaft from the initial position in the rotation direction, the first segment of the activation pattern occurs before the second segment and the second segment occurs before the third segment.

20. The cooking appliance of claim 14, wherein during a fourth segment of the activation pattern the first heating element, second heating element and third heating element are inactive.
